(19) United States
(12) Patent Application Publication
(10) Pub. No.: US 2023/0098024 A1
(43) Pub. Date: Mar. 30, 2023

(54) COOKING ROBOT SYSTEM AND METHOD

(71) Applicant: Aboozar Ghafari, Toronto (CA)

(72) Inventor: Aboozar Ghafari, Toronto (CA)

(21) Appl. No.: 18/075,725

(22) Filed: Dec. 6, 2022

(51) Int. Cl. A47J 27/12; B25J 11/00; B23K 26/402; F24C 7/06; A47J 36/32; A47J 47/01; A47J 43/044; B65B 69/00

(52) U.S. Cl. CPC A47J 27/12; B25J 11/0045; B23K 26/402; F24C 7/067; A47J 36/32; A47J 47/01; A47J 43/044; B65B 69/0033

(57) ABSTRACT

Presented is a cooking robot system. The system includes a housing, a pair of cooking pots, and a motion mechanism to allow each of the cooking pots to perform a movement in 3 Degrees of Freedom (DoF) along horizontal, vertical, and rotational axes. The motion mechanism includes a horizontal motion arrangement, a vertical motion arrangement, and a rotational motion arrangement. The cooking robot system further includes a pair of heating elements rotatably coupled to the rotational motion arrangement. The heating arrangements detachably engage the cooking pots for heating the cooking ingredient contained in the cooking pots. The cooking robot system further includes a stirring mechanism for stirring the contents of the cooking pots, an ingredient-holding container containing cooking ingredients, and a dispenser assembly for selectively dispensing the cooking ingredients contained within the ingredient holding container.

### TECHNICAL FIELD OF INVENTION

The present invention relates to a cooking system, particularly, the present invention relates a portable, automated, and multifunctional cooking robot system and associated method thereof for cooking a variety of food/meals.

### BACKGROUND

Throughout history, cooking a variety of food items has been an area of constant experimentation. Recipes are endlessly being modified, and also preparation techniques for the recipes are also continually being improved. These improvements are aimed at both improving the quality of the automated cooking products pre-existing in the market, and also reducing the time and labor required for the preparation of food. Microwaves, ovens, electric cookers, air fryers, and the like are some very common examples of automated cooking appliances. Although these cooking systems require minimal human intervention for cooking, they are restricted in their cooking programs with respect to a certain type of food to be cooked and thus cannot cook a wide range of foods and can't offer to cook multiple foods simultaneously. Vending machines are another example of a food service system with minimal human intervention. The main drawback to vending machines is their limited menu, and their inability to offer freshly prepared, hot food to the customers at reasonable prices. Restaurants can supply a variety of freshly prepared hot food, but it may not be possible for the restaurants to offer food at affordable costs due to their operational costs.

Also, at homes or restaurants, the quality of the prepared food depends in large part on the consistency and method of food preparation. The food must be cooked under the correct conditions for the proper time. The consistency in food preparation can vary as a result of many factors. For example, people (cook persons) engaged in food preparation often must perform multiple tasks at frequencies that may vary with time because of constantly varying customer demand Food preparation is labor intensive, and the labor cost is a large portion of the total cost of the prepared food in restaurants. An additional problem is that in sparsely populated and other areas where restaurants are located, such as along highways, for example, recruiting sufficient numbers of suitable employees is difficult. Similarly, keeping multiple cooking systems at home may not sound like an idle option for the consumers requiring the variety of food cooked.

Many attempts have been made in the past to devise automated cooking systems to resolve the above-mentioned problems, however, they have their own shortcomings in terms of the variety of foods they can cook, the complexity relating to their mechanical design, the complexity involved in operating those systems, and their expensiveness. For example, U.S. Pat. No. 10,595,660 discloses a portable fully automatic cooking system which can automatically prepare food items as per the user's demand. This machine unit of system can be controlled by any kind of computation device (Eg. phone) for cooking, recording, managing which satisfies hardware and software requirement standards of system which user can control and command through physical presence or from a remote location. Machine unit stores various ingredients inside it and demands chief ingredients and cooks recipes in accordance with recipe using custom developed artificial intelligence. The scalability and flexibility of machine design, structure, components and positioning makes automated cooking possible, efficient and most practical. The capability to add custom vessels, modules and attachments adds extended efficiency in automated cooking.

WO2010052301 discloses a machine for automatically cooking foodstuffs in general, comprising a boiler, a compensation chamber, and cooking means for multiple and differentiated doses of said foodstuffs, these means consisting of at least two cooking chambers, equipped with respective dosing units for the same foodstuffs. Each dosing unit is also provided with an upper conduit, adapted to selectively receive the food from a distributor hopper, arranged rotating above the same dosing units.

U.S. Pat. No. 7,485,830 discloses an automatic cooking device that includes a rotating body and a cooking vessel that can regulate and control cooking processes. The rotating body is connected to a fixed structure, and the cooking vessel is attached on top of the rotating body. The automatic cooking device further utilizes integrated rotating devices, the cooking vessel and several driving motors to perform 3-dimensional movement including rotation, vibration, expanding and contracting motions, swinging or a combination of these motions. The automatic cooking device of the present invention is designed in such that it is simple to use and cost effective yet imparts meals cooked therein with the taste and flavor of food cooked traditionally. In other words, the automatic cooking device can cook various meals rapidly without impairing in quality of taste and flavor of the food. The automatic cooking device also can be used to prepare different meals.

U.S. Pat. No. 10,154,762 describes an automated kitchen system having multiple cooking and/or mixing pots and having containers and dispensers for multiple ingredients. A customer or other person or system selects or creates a meal or other food product and the ingredients for the meal or other product are transferred from dispensers to the cooking and/or mixing pots which simultaneously cook and/or mix the ingredients. After cooking, the meal or other product is served and the cooking pot is cleaned and sanitized and oriented to receive the ingredients for the next meal or other product.

Compared to known cooking devices and machines in this field, the cooking robot system according to the invention offers the advantage of enabling to cook several different food items using one cooking system, thereby overcoming the traditional need to have the same number of cooking systems as the number of foot variety to be cooked. Moreover, the cooking system according to the invention also offers the important advantage of being able to cook, simultaneously, multiple foods requiring reciprocally different food ingredients.

### SUMMARY

It is an object of the present invention to provide an automatic cooking system, that is simple to use and cost-effective and helps users to cook single or multiple different food/meals at the same time.

Another object of the present invention is to provide a cooking robot system that can be easily moved and transported.

Another object of the present invention is to provide an automatic cooking system that can be used to cook various meals and preparations conveniently without impairing in quality of taste and flavor of the meals.

Another object of the present invention is to provide an automatic cooking system and method that offers single or multiple phases of cooking methods as may be required for cooking different food/meals.

Another objective of the present invention provides an automatic cooking system and method that involves an efficient process for automatically dispensing at least one ingredient into the cooking pots, agitating or mixing the at least one ingredient, and cooking the ingredients to form a predetermined food/meal.

Embodiments of the present invention disclose a cooking robot system comprising a housing comprising a body portion, a pair of side walls, a door swingably coupled to at least one of the pair of side walls or the body portion; at least a first cooking pot, and a second cooking pot; and a motion mechanism configured to allow the first cooking pot and/or the second cooking pot to perform the movement in a 3 Degrees of Freedom (DoF) along a horizontal axis, a vertical axis, and a rotational axis.

According to an embodiment of the present invention, the motion mechanism comprising a horizontal motion arrangement, a vertical motion arrangement, and a rotational motion arrangement. According to an embodiment, the horizontal motion arrangement comprising: a first drive motor with a first screw, the first screw passes through a first horizontal carriage and a second horizontal carriage, wherein when operated, the first drive motor rotates the first screw to move the first horizontal carriage over a pair of horizontal guide rails along the horizontal axis; and a second drive motor with a second screw, the second screw passes through the second horizontal carriage and the first horizontal carriage, wherein when operated, the second drive motor rotates the second screw to move the second horizontal carriage over the pair of horizontal guide rails along the horizontal axis. The first drive motor (109a) and the second drive motor (109c) comprises at least a stepper motor or a servo motor.

According to an embodiment, the vertical motion arrangement comprising: a third drive motor with a third screw, the third drive motor is configured on the first horizontal carriage such that the third screw remains erected upwardly in a vertical axis from the first horizontal carriage; and a fourth drive motor with a fourth screw, the fourth drive motor is configured on the second horizontal carriage such that the fourth screw remains erected upwardly in the vertical axis from the second horizontal carriage. The third screw passes through a first vertical carriage and when operated, the third drive motor rotates the third screw to move the first vertical carriage over a first vertical guide rail along the vertical axis. The fourth screw passes through a second vertical carriage and when operated, the fourth drive motor rotates the fourth screw to move the second vertical carriage over a second vertical guide rail along the vertical axis. the third drive motor and the fourth drive motor comprises at least a stepper motor or a servo motor.

According to an embodiment, the rotational motion arrangement comprising: a fifth drive motor with a first drive shaft, wherein one of the heating elements of the pair of heating elements is rotatably coupled to the first drive shaft; and a sixth drive motor with a second drive shaft, wherein one of the heating elements of the pair of heating elements is rotatably coupled to the second drive shaft. The fifth drive motor and/or the sixth drive motor when operated rotate the first drive shaft and/or the second drive shaft) to rotate the first cooking pot and/or the second cooking pot detachably engaged to the pair of heating elements. The fifth drive motor and the sixth drive motor comprises at least a stepper motor or a servo motor.

In an embodiment, the cooking robot system further includes a pair of heating elements rotatably coupled to the rotational motion arrangement, wherein each of the pair of heating arrangements detachably engages to the first cooking pot, and the second cooking pot for heating at least one cooking ingredient contained therein.

In an embodiment, the cooking robot system further includes a stirring mechanism configured within the housing for stirring the contents of the first cooking pot or the second cooking pot. The stirring mechanism comprising: a first stirring drive motor encased inside a first casing, the first stirring drive motor comprises a stirring shaft engaged to the first stirring drive motor at one end and to a stirrer at another end; and a second stirring drive motor encased inside a second casing, the second stirring drive motor comprises a swing arm engaged thereto at one end and to the first casing at another end.

In an embodiment, the cooking robot system further comprises one or more trays placed inside the body portion of the housing and underneath the first cooking pot and the second cooking pot.

In an embodiment, the cooking robot system further comprising: a first water storage and spray unit configured inside the housing and a second water storage and spray unit. The first water storage and spray unit comprising a first water tank with a spray pump there inside, and a first water spray nozzle for selectively spraying water into the first cooking pot (106).The second water storage and spray unit comprising a second water tank with a spray pump there inside, and a second water spray nozzle for selectively spraying water into the second cooking pot.

In an embodiment, the cooking robot system further includes at least one ingredient holding container containing the at least one cooking ingredient. The ingredient holding container is configurable on top of the body portion of the housing such that bottom of the ingredient holding container remains exposed within the interior of the housing. In one embodiment, the at least one ingredient holding container comprising one or more spaced compartments on top for holding the one or more ingredients therein. the at least one ingredient holding container includes a stretched elastic film attached at the bottom of the ingredient holding container. In another embodiment, each of the one or more spaced compartments includes a stretched elastic film attached to the bottom of each of the one or more spaced compartments. In yet another embodiment, each of the one or more spaced compartments includes a retractable film attached to the bottom of each of the one or more spaced compartments using a suitable adhesive.

In an embodiment, the cooking robot system further includes a dispenser assembly configured inside the housing for selectively dispensing the at least one cooking ingredient contained within the ingredient holding container. The dispenser assembly comprising a laser module held by a laser casing; a first motor with a screw, wherein the motor is operated to move the laser casing on the screw in support of a laser guide rail along the horizontal axis; and a second motor driving a mirror to auto-focus the laser light on the bottom of the ingredient holding container exposed within the interior of the housing for dispensing the at least one ingredient contained inside the ingredient holding container.

These and other features and advantages along with other embodiments of the present invention will become apparent from the detailed description below, in light of the accompanying drawings.

### BRIEF DESCRIPTION OF DRAWINGS

In the drawings:

FIGS. 1 and 2 illustrate a front perspective view of a cooking robot system of the present invention, according to an exemplary embodiment of the present invention.

FIGS. 3 and 4 illustrate an exploded view of the cooking robot system of FIG. 1.

FIG. 5 illustrates a partial sectional view of the interior of the cooking robot system of FIG. 1.

FIG. 6 illustrates a back perspective view of a motion mechanism implemented in the cooking robot system of FIG. 1 that facilitates independent movement for each of the cooking pots in 3 DoF, according to an exemplary embodiment.

FIG. 7 illustrates a front perspective view of the motion mechanism of FIG. 7 without the cooking pots.

FIG. 8 illustrates an exploded view of the motion mechanism shown in FIGS. 6 and 7.

FIGS. 9 and 10 illustrate a back perspective view and a front perspective view of the cooking pot of FIG. 1 according to an exemplary embodiment.

FIGS. 11-13 illustrate different possible configurations or cooking pot arrangements achieved through the motion mechanism of FIGS. 7 and 8.

FIGS. 14-16 illustrates different possible configurations or cooking pot arrangements that require the cooking pots to move in all three DoF.

FIG. 17 illustrates a top view of a horizontal motion arrangement of the motion mechanism of FIGS. 6 and 7, according to one exemplary embodiment.

FIG. 18 illustrates a vertical motion arrangement of the motion mechanism of FIGS. 6 and 7, according to one exemplary embodiment.

FIG. 19 illustrate a laser dispenser assembly configured to trigger dispensing of at least one ingredient from an ingredient holding and dispensing container configurable on the cooking robot system of FIG. 1, according to one exemplary embodiment.

FIGS. 20-21, shows a top perspective and a bottom perspective view of an ingredient holding, according to an exemplary embodiment.

FIG. 22 shows a cross sectional view of the ingredient holding container of FIG. 20 taken along A-A′.

FIG. 23 shows a top perspective view of the ingredient holding container, according to an alternative embodiment.

FIG. 24 shows a dispenser assembly in action to burst out a stretched elastic film configured at the bottom of a compartment of the ingredient holding container in order to dispense out the ingredient held inside the compartment, according to an exemplary embodiment.

FIG. 25 shows a top perspective view of the ingredient holding container, according to yet another alternative embodiment.

### DETAILED DESCRIPTION

Some embodiments, illustrating its features, will now be discussed in detail. The words “comprising,” “having,” “containing,” “including,” “consisting,” and other forms thereof, are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise. Although any methods, and systems similar or equivalent to those described herein can be used in the practice or testing of embodiments, the preferred methods, and systems are now described. The disclosed embodiments in description and drawings are merely exemplary.

References to “one embodiment”, “an embodiment”, “another embodiment”, “an example”, “another example”, “some embodiment”, “yet another embodiment”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment. Unless stated otherwise, terms such as “first”, “second”, “third”, are used to arbitrarily distinguish between the elements such terms describe. Thus, these terms are not necessarily intended to indicate temporal or other prioritization of such elements.

Before describing the present invention in detail, it should be observed that the present invention relates to a portable, automated, and multifunctional cooking robot system. Accordingly, the components have been represented, showing only specific details that are pertinent for an understanding of the present invention so as not to obscure the disclosure with details that will be readily apparent to those with ordinary skill in the art having the benefit of the description herein. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting but as a representative basis for teaching one skilled in the art to variously employ the present invention in virtually any appropriately detailed structure. Further, the terms and phrases used herein are not intended to be limiting but rather to provide an understandable description of the invention.

Although not discussed in detail and in fact omitted from the detailed description, the functionalities/operations of the cooking system and associated components involves the use of a control circuitry that uses one or more PCBs, microprocessors/microcontrollers, memory modules, timers, different sensors, and other known electronic/mechanical components, operations of which is well known by a person skilled in the art. The microprocessors/microcontrollers may be preprogrammed to enable a user to control and manage the operations of said components via the control circuitry housed within the proposed cooking system. The instructions/commands for controlling the various housed components may be given using different forms of input devices including mechanical/electronic switches/buttons, electronic touch panel, etc. In the context of the present invention, a control circuitry is necessary for at least but not limited to the functioning of a motion mechanism, a pair of heating elements engaged to a first and second cooking pots, a stirring mechanism, a dispenser assembly.

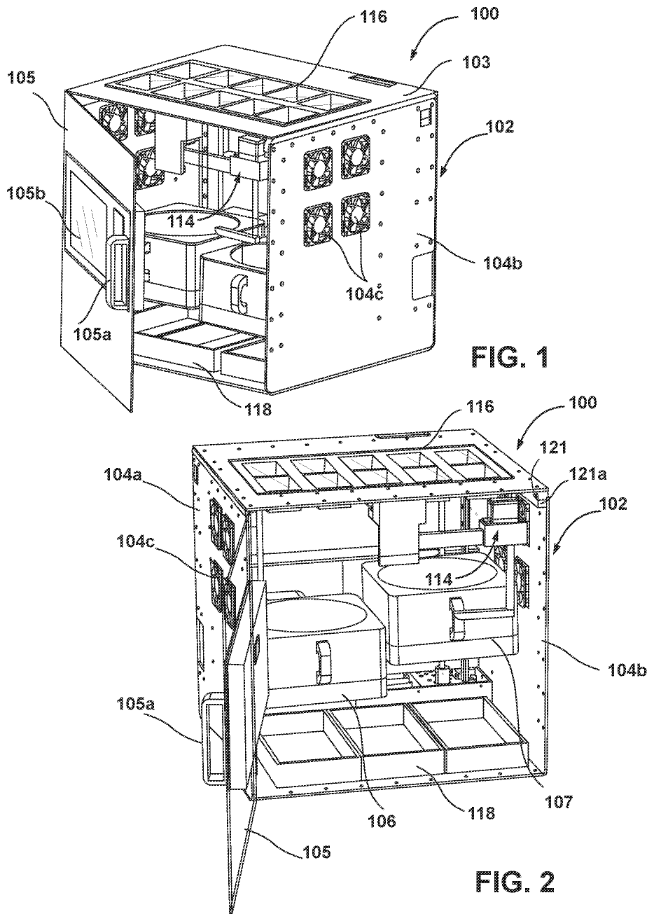

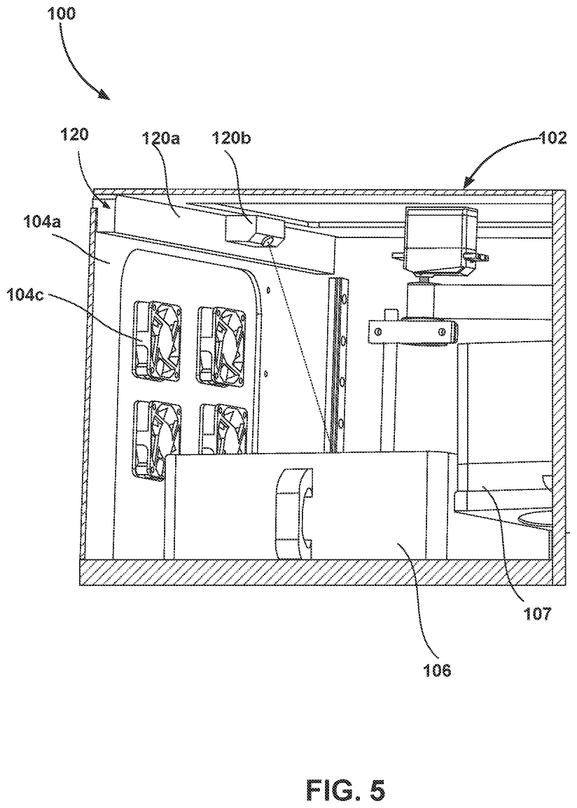

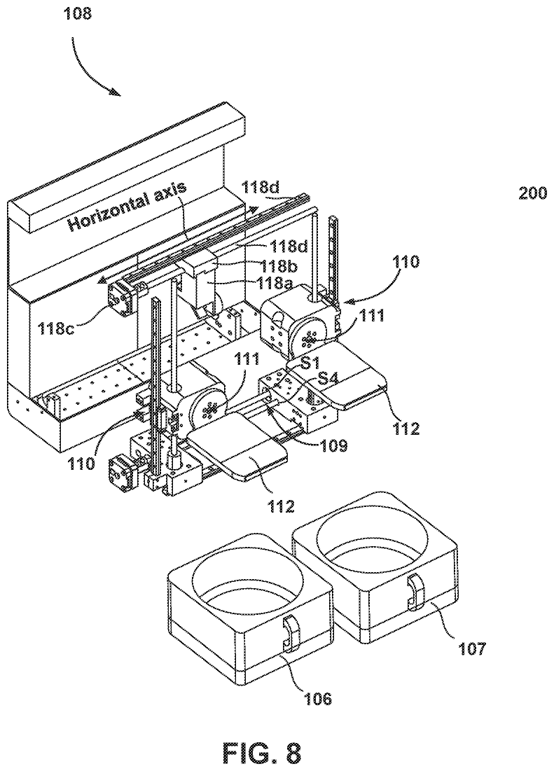

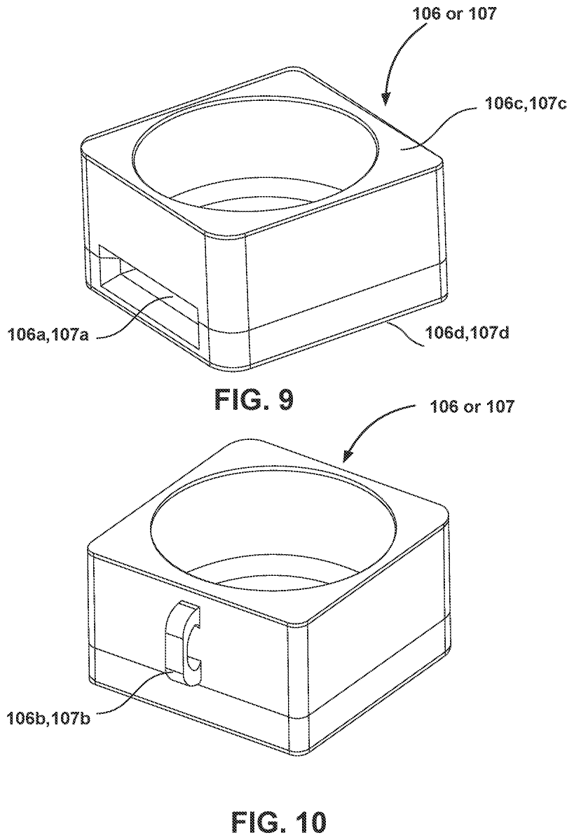

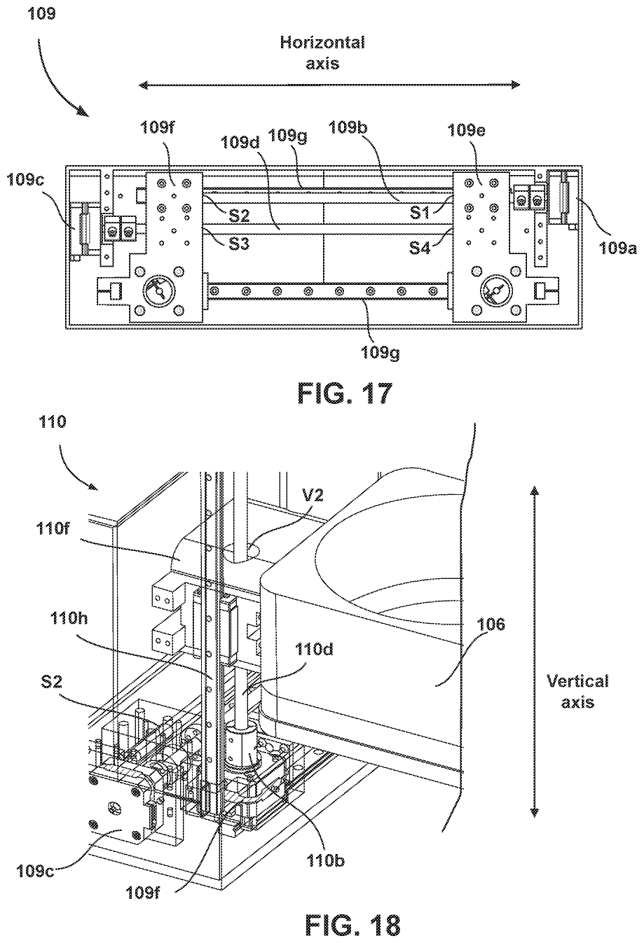

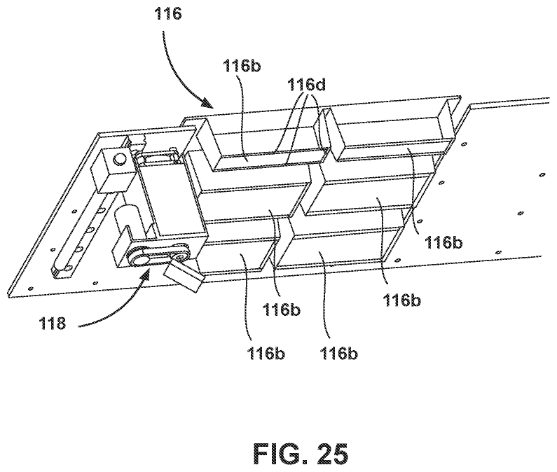

The various features and embodiments of the portable, automated, and multifunctional cooking robot system of the present invention are better explained in conjunction with FIGS. 1-25.

Referring to the accompanying figures, particularly FIGS. 1-4, the cooking robot system 100 includes a housing 102. The housing 102 may be subdivided as a body portion 103, and a pair of side walls 104a, 104b. The body portion 103 essentially includes a top 103a, a bottom/base 103c, and a back 103b. The body portion 103 may be formed as a single unitary product or as separate three parts that can be assembled using suitable fasteners. The body portion 103 and the side walls 104a,104b are essentially assembled using suitable fasteners. The housing 102 further includes a door 105 that may be swingably coupled to at least one of the pair of side walls 104a, 104b as seen in FIGS. 1-3 or to the top 103a and bottom 103c of the body portion 103. The door 105 is configured to access the interior of the housing 102 including components housed therein. The door 105 may also be used for accessing cooking pots 106,107 once the food is prepared and for cleaning the cooking pots. The door 105 may be provided with a handle 105a to facilitate the opening and closing of the door 105. The housing 102 may preferably be made of metal, metal alloy, or any other suitable material known in the art. As seen, according to an embodiment, at the top 103a of the body portion 103 of the housing 102, a cut out section 103d is made to receive and uphold at least one ingredient holding container 116 containing at least one cooking ingredient without requiring a user to open the door 105. In some other embodiment, the top 103a of the body portion 103 may have a drawer like provision configured for a user to slide in and out of the ingredient holding container 116 by opening the door 105 or without requiring the opening of the door 105. Additionally, in an embodiment, the top 103a may include provisions for allowing a user to fill in water inside a first and second water storage and spray units 120,121 configured inside the housing 102 which would be discussed in greater detail in the description to follow.

In an embodiment, as seen, the door 105 may further include an input/output electronic device panel 105b. The input/output electronic device panel 105b may allow a user of the cooking system 100 to input commands related to the food being prepared or for controlling and managing the cooking in progress. The input/output electronic device panel 105b may facilitate the user to view the interior cooking environment of the cooking system 100. The viewing of the cooking environment (Eg live cooking view) may be made possible using one or more image capturing means 105c (Eg. Cameras) that may be configured within the housing or on the input/output electronic device panel 105b. The input/output electronic device panel 105b display certain outputs related to food being prepared, error messages, or instructions for the user to follow up during the course of cooking and so on. In some other embodiments, the mechanical/electronic buttons (not seen) may be installed on door 105 or other locations on the housing 102 for inputting the commands related to the cooking of food/meals and for controlling and managing the cooking operation, etc. In some other embodiments, both the input/output electronic device panel 105b along with mechanical/electronic buttons/switches may be used. In some other embodiment, the input/output commands may be given using an electronic device (Eg. a phone) held by the user utilizing a program product (developed for controlling the functionalities of the cooking system 100) installed in the user's electronic device.

Further as seen, the side walls 104a, 104b of the housing 102 may include one or more ventilation arrangements 104c (E.g. fans) that may assist in venting out hot air, steam, gases, fumes, etc. from the cooking system 100 during its operation. Further, the ventilation arrangement 104c may be operated to even cook certain food/meals using the supplied heat and air from the ventilation arrangements 104c that can circulate around the food just like any conventional air fryer.

Referring to FIGS. 1-4 and 9-10, the cooking system 100 includes at least a first cooking pot 106, and a second cooking pot 107. The cooking pots 106,107 are essentially made identical in shape to serve the purpose of cooking a variety of food/meals. In an embodiment, as shown, the exterior body of the cooking pots 106,107 is made square shaped, whereas the interior cavity for holding the cooking ingredients is made circular in shape. However, it should be understood that the cooking pots 106, and 107 including the interior cavity for holding the cooking ingredients may be made in different other shapes such as for example circular, rectangular, polygonal, etc. The cooking pots 106, 107 may be made using a variety of materials known in the art. In an example embodiment, the outer body of the cooking pots 106,107 may be preferably made of heat-insulating material. The top layer 106c 107c and bottom layers 106d,107d of the cooking pots 106,107 may be made of silicon or similar soft material to seal the attachment between the two pots 106,107 when one of the cooking pots 106,107 acts as a lid for the other pot 106,107 (the top layers 106c 107c of both the pots attaches together) or when the bottom layer 106d 107d of one of the pots 106,107 sits on top layer 106c 107c of the other pot 106,107. As seen, the cooking pots 106,107 further include a slot 106a,107a that allows a pair of heating arrangements 112 (that heats the food content held in the cooking pots 106,107) to detachably engage with the cooking pots 106, 107. The cooking pots 106,107 also include a handle 106b,107b that allows the user to attach and detach the cooking pots 106,107 to and from the pair of heating arrangements 112.

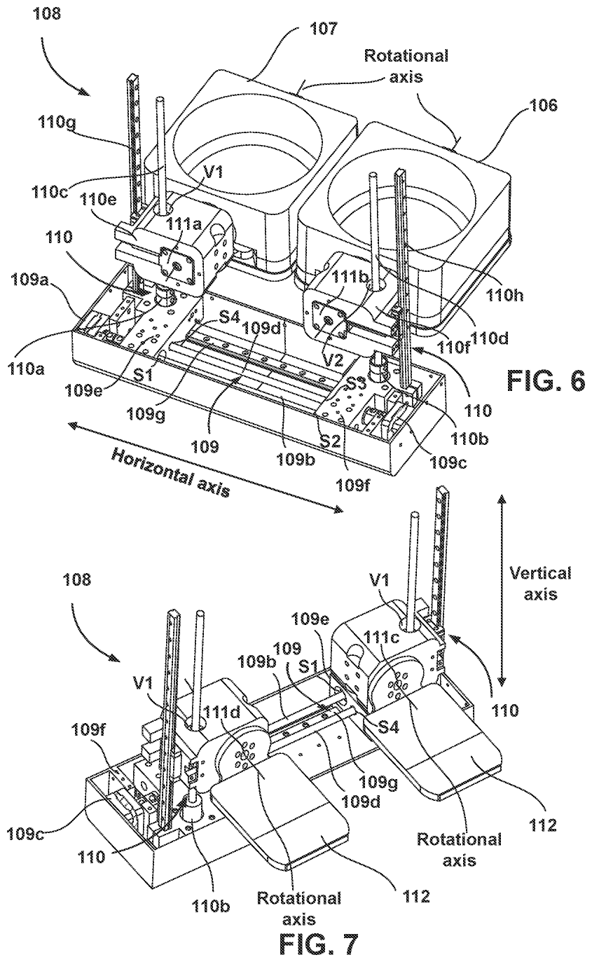

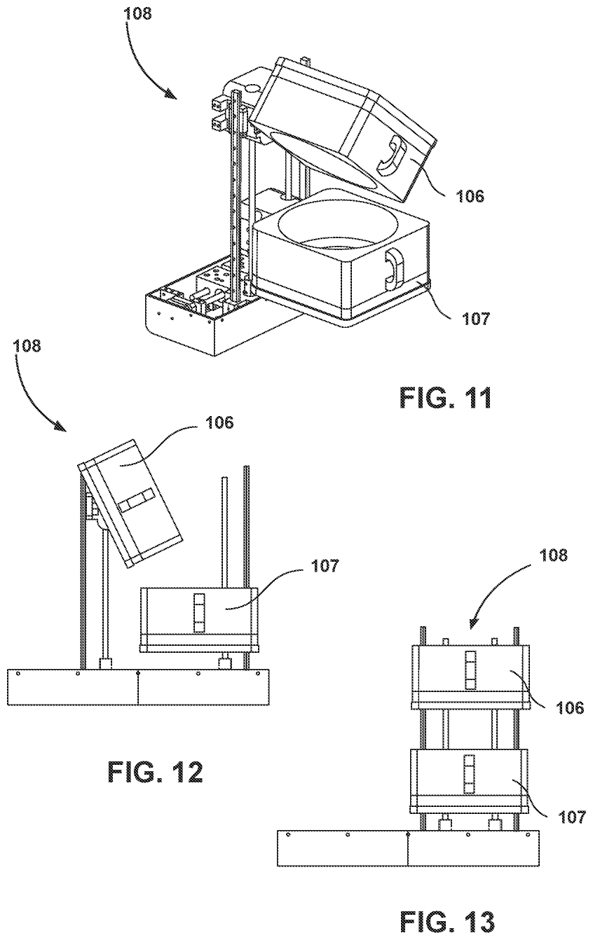

As the essence of the present invention, and at least shown in FIGS. 6-8, and FIGS. 17-18, the cooking system 100 uses a motion mechanism 108 configured within the housing 102 to allow the first cooking pot 106 and second cooking pot 107 to independently perform the movement in a 3 Degrees of Freedom (DoF) along a horizontal axis, a vertical axis, and a rotational axis. The innovative motion mechanism facilitates the pots 106,107 to orient in many different configurations or arrangements as shown in FIGS. 11-16. The motion mechanism 108 of the proposed invention can essentially be divided into a horizontal motion arrangement 109, a vertical motion arrangement 110, and a rotational motion arrangement 111 which will be discussed in detail in the description to follow.

In an embodiment, the horizontal motion arrangement 109 includes a first drive motor 109a with a first screw 109b. The screw 109b passes through a first horizontal carriage 109e and a second horizontal carriage 109f using the slots S1 and S2 respectively. In operation, when the first drive motor 109a receives the command from the control circuitry, it rotates the screw 109b to produce linear actuation to move the carriage 109e over a pair of horizontal guide rails 109g along the horizontal axis. The movement of the carriage 109e is linear in a forward or backward direction depending upon the requirement. In other words, the carriage 109e is moved towards or away from the carriage 109f. The speed of movement of the carriage 109e is controllable by the user by giving appropriate commands In some embodiments, the movements are controllable automatically depending upon the recipe being cooked. Additionally, the horizontal motion arrangement 109 includes a second drive motor 109c with a second screw 109d. The screw 109d passes through the second horizontal carriage 109f and the first horizontal carriage 109e via slots S3 and S4 respectively. In operation, the drive motor 109c rotates the screw 109d to produce linear actuation to move the carriage 109f over the pair of horizontal guide rails 109g along the horizontal axis. The movement of the carriage 109f is linear in a forward or backward direction depending upon the requirement. In other words, the carriage 109f is moved towards or away from the carriage 109e. The speed of movement of the carriage 109f is controllable by the user by giving appropriate command In some embodiments, the movements are controllable automatically depending upon the recipe being cooked. In an example embodiment, the drive motors 109a, and 109c may include but not limited to a stepper motor or a servo motor with the desired specification.

In an embodiment, the vertical motion arrangement 110 includes a third drive motor 110a with a third screw 110c. The drive motor 110a is configured on the first horizontal carriage 109e such that the screw 110c remains erected upwardly in a vertical axis from the carriage 109e. The screw 110c passes through a first vertical carriage 110e via slot V1. In operation, the third drive motor 110a (upon receiving a command from the control circuitry) rotates the screw 110c to produce linear actuation to move the carriage 110e over a first vertical guide rail 110g along the vertical axis. The vertical motion arrangement 110 further includes a fourth drive motor 110b with a fourth screw 110d. The motor 110b is configured on carriage 109f such that the screw 110d remains erected upwardly in the vertical axis from the carriage 109f. The screw 110d passes through a second vertical carriage 110f via slot V2. In operation, the drive motor 110b rotates the screw 110d to produce linear actuation to move the carriage 110f over a second vertical guide rail 110h along the vertical axis. The drive motors 110a, 110b may include but not limited to a stepper motor, and a servo motor with the desired specification.

In an embodiment, the rotational motion arrangement 111 includes a fifth drive motor 111a with a first drive shaft 111c. As seen, one of the heating elements 112 is rotatably coupled to the drive shaft 111c of the motor 111a so that the heating element 112 engaging the corresponding cooking pot 107 can rotate the cooking pot 107 along the rotational axis. The rotational motion arrangement 111 further includes a sixth drive motor 111b with a second drive shaft 111d. As seen, one of the heating elements 112 is rotatably coupled to the second drive shaft (111d) of the motor 111b so that the heating element 112 engaging the corresponding cooking pot 106 can rotate the cooking pot 106 along the rotational axis. The rotation of the drive shafts 111c, 111d may be clockwise or anticlockwise. In an embodiment, the drive motors 111a, 111b may include but not limited to a stepper motor or a servo motor.

All of these, horizontal motion arrangement 109, vertical motion arrangement 110, and rotational motion arrangement 111 helps in orienting the cooking pots 106,107 in different orientations depending upon the cooking requirement or recipe. For example, FIG. 11 and 12 shows the cooking pot 106 oriented in a manner to pour some ingredient into the other cooking pot 107 (so to say receiving pot). In these particular examples, it can be seen that only the cooking pot 106 is moved in along the horizontal axis, the vertical axis, and the rotational axis to orient itself in the pouring position over the cooking pot 107. Likewise, FIG. 13 shows the base/bottom 106d of the cooking pot 106 oriented over the top 107c of the cooking pot 107 in a spaced apart relation. On the other hand, FIG. 16 shows the base/bottom 106d of the cooking pot 106 oriented exactly on the top 107c of the cooking pot 107 without any spacing. In these particular examples, the cooking pot 6 is moved along the horizontal axis and the vertical axis without any rotation along the rotational axis, thus utilizing only the horizontal motion arrangement 109, and the vertical motion arrangement 110 unlike FIGS. 11-12 where the cooking pot 6 is moved utilizing all three motions, namely, the horizontal motion arrangement 109, vertical motion arrangement 110, and rotational motion arrangement 111. These configurations or cooking pot arrangements may be useful for cooking different types of food/meals such as steam cooking rice.

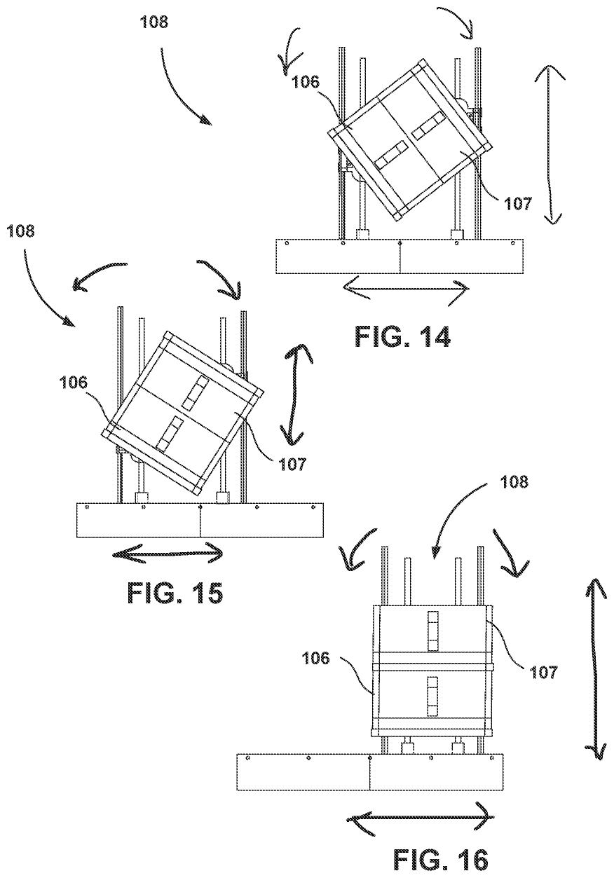

FIGS. 14-15 shows different possible configurations or cooking pot arrangements that require the cooking pots 106,107 to move in all three DoFs. As seen, one of the cooking pots 106,107 acts as a lid or cover for the other pot. For example, as seen in FIGS. 14-15, the cooking pot 6 acts as a lid for the other pot 107 and vice versa. Such configurations may be useful for a variety of cooking applications such as baking a cake placed in one of the pots 106,107, air frying the content held in one of the pots 106,107.

Referring to FIGS. 6, 7, and 9, as seen and can be understood, the heating elements 112 rotatably couple to the rotational motion arrangement 111, and each of the heating arrangements 112 detachably engage to the cooking pots 106, 107 for heating at least one cooking ingredient contained inside the pots 106,107. The heating arrangements 112 engages cooking pots 106, 107 through the slots 106a,107a of the cooking pots 106,107.

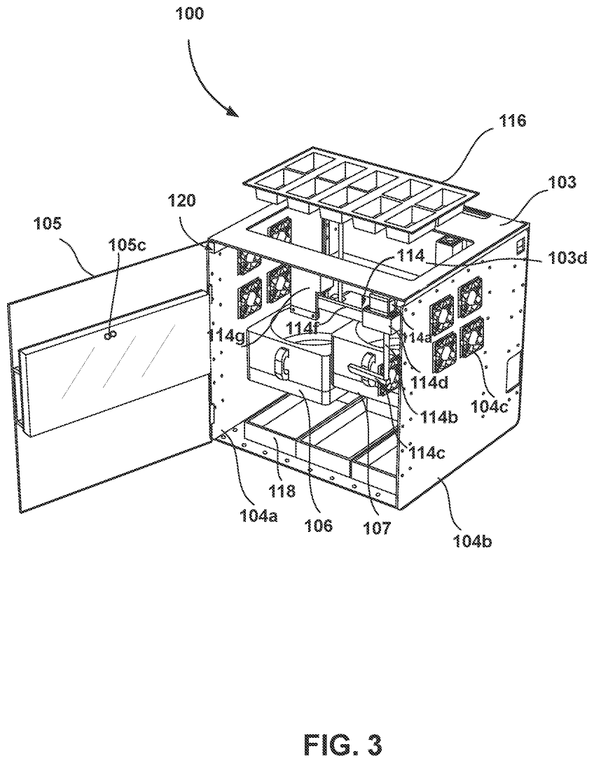

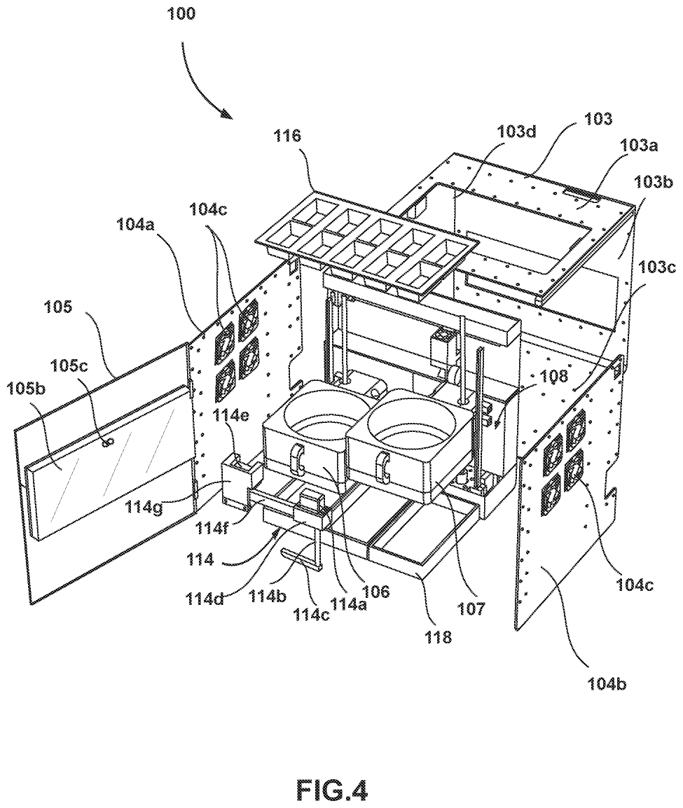

Referring to FIGS. 3-4, the cooking robot system 100 of the present invention includes a stirring mechanism 114 configured within the housing 102 for stirring the contents held in the cooking pots 106, 107. The stirring mechanism 114 includes a first stirring drive motor 114a encased inside a first casing 114d. The drive motor 114a includes a stirring shaft 114b engaged to the drive motor 114a at one end and to a stirrer 114c at another end. In a particular example, the stirrer 114c is made as a horizontal member, but it should be understood that the stirrer 114c may be made in a variety of designs. Further, in an embodiment, the stirring mechanism 114 is seen configured or installed in a front portion of the housing 102. Specifically, the first casing 114d holding the motor 114a is attached underside the top 103a of the body portion at the entry of the housing without affecting the operation of the door 105. In an embodiment, the stirring mechanism 114 additionally includes a second stirring drive motor 114e encased inside a second casing 114g. The drive motor 114e comprises a swing arm 114f engaged thereto at one end and to the first casing 114d at another end. The drive motor 114e is when operated functions to displace the stirring shaft 114b with the stirrer 114c towards interior of the housing 102. The displacement is to ensure the stirring shaft 114b with the stirrer 114c is aligned and laid inside the cooking pot 106 or the cooking pot 107. According to the embodiment, the drive motor 114a is operated to rotate the stirrer 114c in a clockwise and/or anticlockwise direction to mix the content of the cooking pot 106 or the cooking pot 107. The motors 114a, 114e may include but are not limited to a servo motor, and a stepper motor.

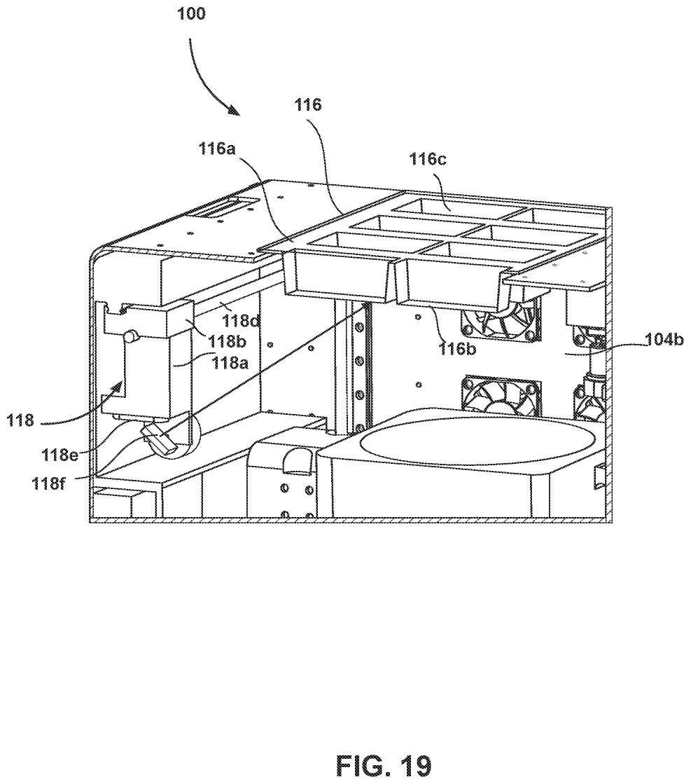

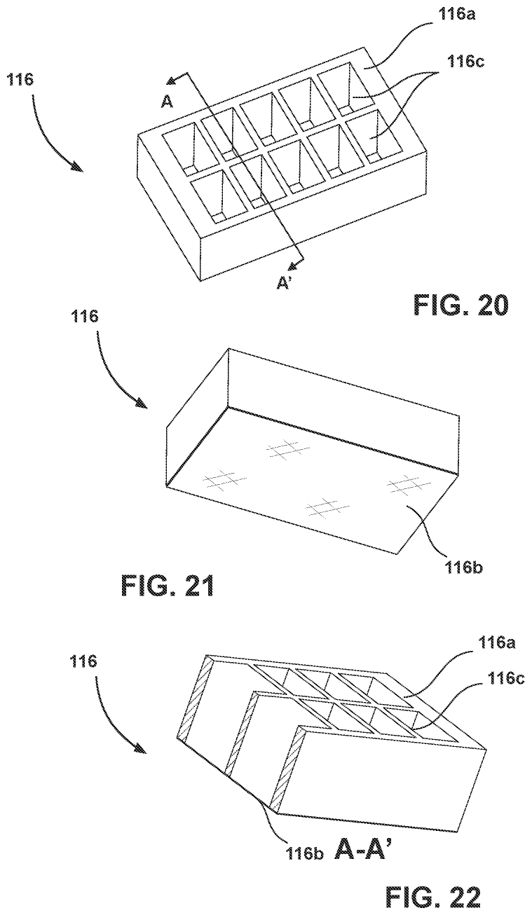

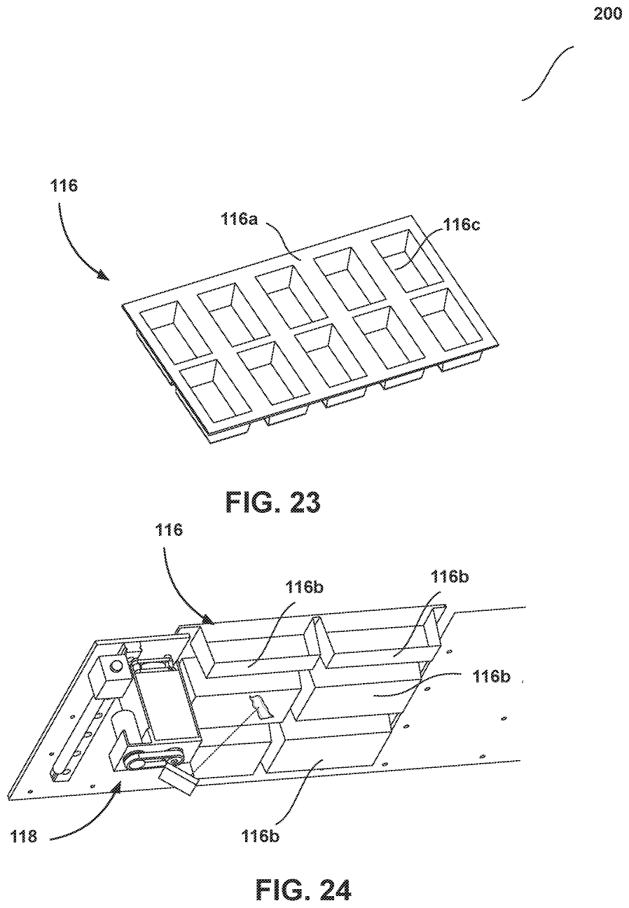

Referring to FIG. 3, and FIGS. 19-25, the cooking system 100 includes at least one ingredient holding container 116 containing at least one cooking ingredient. The ingredient holding container 116 is configurable on top of the body portion 103 of the housing 102 by inserting the same onto the cut-out section 103d. As seen, when installed, the bottom of the ingredient holding container 116 remains exposed within the interior of the housing 102. As seen, the ingredient holding container 116 includes one or more spaced compartments 116c on top 116a for holding the ingredients there inside (FIG. 20). As seen in FIG. 21, according to one embodiment, the ingredient holding container 116 includes a single stretched elastic film 116b attached at the bottom of the ingredient holding container 116 for covering all of the spaced compartments 116c. Further as seen in FIGS. 23-24, each of the one or more spaced compartments 116c includes a stretched elastic film 116b attached to the bottom of each of the spaced compartments 116c according to another example embodiment. Furthermore, in some other embodiment, each of the spaced compartments 116c may include a retractable film 116b attached to the bottom of each of the spaced compartments 116c using an adhesive (E.g. tape on three sides). For example, the retractable film 116b may be fixed or bonded to the bottom of the spaced compartments 116c at just one side, and on the other three sides, the retractable film 116b may be attached to the bottom of each of the spaced compartments 116c using the tapes 116d.

Referring to FIGS. 18-19 and FIGS. 24-25, the cooking system 100 further includes a dispenser assembly 118 configured inside the housing 102 for selectively dispensing the cooking ingredient contained within the ingredient holding container 116. The dispenser assembly 118 according to the preferred embodiment may be a laser dispenser assembly capable of targeting the laser beam (emitted by a laser module 118a) on the bottom of the ingredient holding container 116 in order to cut/burst the stretchable elastic film/retractable film attached to the bottom of the compartments 116c holding the ingredients to dispense the ingredients out therefrom into the cooking pots 106,107. According to the embodiment, the dispenser assembly 118 includes the laser module 118a held by a laser casing 118b. The dispenser assembly 118 further includes a first motor 118c with a screw 118d. The motor 118c is operated to move the laser casing 118b linearly on the screw 118d in support of a laser guide rail 118d along the horizontal axis. The dispenser assembly 118 further includes a second motor 118e driving a mirror 118f to auto-focus the laser light on the bottom of the ingredient holding container 116 exposed within the interior of the housing 102 for dispensing out the ingredient contained inside the ingredient holding container 116. The stretchable film layer or retractable film covering the bottom of the ingredient holding container 116 may be cut from the sides or burst around (FIG. 24) to dispense the ingredients out of the corresponding compartment 116c for cooking the desired food.

Referring to FIGS. 2-3 and FIG. 5, the cooking system 100 further a first water storage and spray unit 120 and a second water storage and spray unit 121 configured inside the housing 102. The water filling provisions (not seen) provided on the top 103a of the body portion 103 helps in filling water inside the water storage and spray units 120,121. The water storage and spray units 120,121 are configured on top of two side walls 104a, 104b respectively according to a preferred embodiment. The first water storage and spray unit 120 includes a first water tank 120a with a spray pump there inside, and a first water spray nozzle 120b for selectively spraying water into the cooking pot 106. In a similar fashion, the second water storage and spray unit 121 includes a second water tank 121a with a spray pump there inside and a second water spray nozzle 121b for selectively spraying water into the cooking pot 107. The water collection in the pots 106,107 may be needed during the cooking operation. The selective operation of these water storage and spray units 120, 121 would fulfill the water collection requirement during the cooking process of the food.

The cooking system 100 further includes one or more trays or plates 118 placed inside the body portion 103 of the housing 102. Specially placed on the bottom 103c of the body portion 103 and underneath the first cooking pot 106 and the second cooking pot 107. The trays 118 may be useful for various purposes, for example, to collect overflow of food content from the pots 106,107.

Although particular embodiments of the invention have been described in detail for purposes of illustration, various modifications and enhancements may be made without departing from the spirit and scope of the invention.

What is claimed is:

1. A cooking robot system (100), comprising:
a housing (102) comprising a body portion (103), a pair of side walls (104a, 104b), a door (105) swingably coupled to at least one of the pair of side walls (104a, 104b) or the body portion (103);
at least a first cooking pot (106), a second cooking pot (107);
a motion mechanism (108) configured to allow the first cooking pot (106) and/or the second cooking pot (107) to perform the movement in a 3 Degrees of Freedom (DoF) along a horizontal axis, a vertical axis, and a rotational axis, wherein the motion mechanism (108) comprising a horizontal motion arrangement (109), a vertical motion arrangement (110), and a rotational motion arrangement (111);
a pair of heating elements (112) rotatably coupled to the rotational motion arrangement (111), wherein each of the pair of heating arrangements (112) detachably engages to the first cooking pot (106), and the second cooking pot (107) for heating at least one cooking ingredient contained therein;
a stirring mechanism (114) configured within the housing (102) for stirring the contents of the first cooking pot (106) or the second cooking pot (107);
at least one ingredient holding container (116) containing the at least one cooking ingredient, the ingredient holding container (116) is configurable on top of the body portion (103) of the housing (102) such that bottom of the ingredient holding container (116) remains exposed within the interior of the housing (102); and
a dispenser assembly (118) configured inside the housing (102) for selectively dispensing the at least one cooking ingredient contained within the ingredient holding container (116).

2. The cooking robot system (100) of claim 1, wherein each of the pair of side walls (104a, 104b) comprises one or more ventilation arrangements (104c).

3. The cooking robot system (100) of claim 2, wherein the one or more ventilation arrangements (104c) comprises one or more fans.

3. The cooking robot system (100) of claim 1, wherein the door (105) comprises an input/output electronic panel for allowing a user of the cooking robot system (100) to key in input commands relating to the food being prepared thereon and for facilitating the user to view inside cooking environment and/or display certain outputs related to food being prepared.

4. The cooking robot system (100) of claim 1, wherein the horizontal motion arrangement (109) comprising:
a first drive motor (109a) with a first screw (109b), the first screw (109b) passes through a first horizontal carriage (109e) and a second horizontal carriage (109f), wherein when operated, the first drive motor (109a) rotates the first screw (109b) to move the first horizontal carriage (109e) over a pair of horizontal guide rails (109g) along the horizontal axis; and
a second drive motor (109c) with a second screw (109d), the second screw (109d) passes through the second horizontal carriage (109f) and the first horizontal carriage (109e), wherein when operated, the second drive motor (109c) rotates the second screw (109d) to move the second horizontal carriage (109f) over the pair of horizontal guide rails (109g) along the horizontal axis.

5. The cooking robot system (100) of claim 4, wherein the first drive motor (109a) and the second drive motor (109c) comprises at least a stepper motor or a servo motor.

6. The cooking robot system (100) of claim 1, wherein the vertical motion arrangement (110) comprising:
a third drive motor (110a) with a third screw (110c), the third drive motor (110a) is configured on the first horizontal carriage (109e) such that the third screw (110c) remains erected upwardly in a vertical axis from the first horizontal carriage (109e); and
a fourth drive motor (110b) with a fourth screw (110d), the fourth drive motor (110b) is configured on the second horizontal carriage (109f) such that the fourth screw (110d) remains erected upwardly in the vertical axis from the second horizontal carriage (109f).

7. The cooking robot system (100) of claim 6, wherein the third screw (110c) passes through a first vertical carriage (110e) and when operated, the third drive motor (110a) rotates the third screw (110c) to move the first vertical carriage (110e) over a first vertical guide rail (110g) along the vertical axis.

8. The cooking robot system (100) of claim 6, wherein the fourth screw (110d) passes through a second vertical carriage (1100, and when operated, the fourth drive motor (110b) rotates the fourth screw (110d) to move the second vertical carriage (110f) over a second vertical guide rail (110h) along the vertical axis.

9. The cooking robot system (100) of claim 6, wherein the third drive motor (110a) and the fourth drive motor (110b) comprises at least a stepper motor or a servo motor.

10. The cooking robot system (100) of claim 1, wherein the rotational motion arrangement (111) comprising:
a fifth drive motor (111a) with a first drive shaft (111c), wherein one of the heating elements of the pair of heating elements (112) is rotatably coupled to the first drive shaft (111c); and
a sixth drive motor (111b) with a second drive shaft (111d), wherein one of the heating elements of the pair of heating elements (112) is rotatably coupled to the second drive shaft (111d).

11. The cooking robot system (100) of claim 10, wherein the fifth drive motor (111a) and/or the sixth drive motor (111b) when operated rotate the first drive shaft (111c) and/or the second drive shaft (111d) to rotate the first cooking pot (106) and/or the second cooking pot (107) detachably engaged to the pair of heating elements (112).

12. The cooking robot system (100) of claim 10, wherein the fifth drive motor (111a) and the sixth drive motor (111b) comprises at least a stepper motor or a servo motor.

13. The cooking robot system (100) of claim 1, wherein the stirring mechanism (114) comprising:
a first stirring drive motor (114a) encased inside a first casing (114d), the first stirring drive motor (114a) comprises a stirring shaft (114b) engaged to the first stirring drive motor (114a) at one end and to a stirrer (114c) at another end; and
a second stirring drive motor (114e) encased inside a second casing (114g), the second stirring drive motor (114e) comprises a swing arm (114f) engaged thereto at one end and to the first casing (114d) at another end.

14. The cooking robot system (100) of claim 13, wherein the second stirring drive motor (114e) is operated to selectively displace the stirring shaft (114b) with the stirrer (114c) towards interior of the housing (102) to ensure the stirring shaft (114b) with the stirrer (114c) is aligned and laid inside the first cooking pot (106) or the second cooking pot (107).

15. The cooking robot system (100) of claim 13, wherein the first stirring drive motor (114a) is operated to rotate the stirrer (114c) in a clockwise and/or anticlockwise direction to mix the content of the first cooking pot (106) or the second cooking pot (107).

16. The cooking robot system (100) of claim 1 further comprising one or more trays (118) placed inside the body portion (103) of the housing (102) and underneath the first cooking pot (106) and the second cooking pot (107).

17. The cooking robot system (100) of claim 1 further comprising:
a first water storage and spray unit (120) configured inside the housing (102), the first water storage and spray unit (120) comprising a first water tank (120a) with a spray pump there inside, and a first water spray nozzle (120b) for selectively spraying water into the first cooking pot (106); and
a second water storage and spray unit (121) configured inside the housing (102), the second water storage and spray unit (121) comprising a second water tank (121a) with a spray pump there inside, and a second water spray nozzle (121b) for selectively spraying water into the second cooking pot (107).

18. The cooking robot system (100) of claim 1, wherein the dispenser assembly (118) comprising
a laser module (118a) held by a laser casing (118b);
a first motor (118c) with a screw (118d), wherein the motor (118c) is operated to move the laser casing (118b) on the screw (118d) in support of a laser guide rail (118d) along the horizontal axis; and
a second motor (118e) driving a mirror (118f) to auto-focus the laser light on the bottom of the ingredient holding container (116) exposed within the interior of the housing (102) for dispensing the at least one ingredient contained inside the ingredient holding container (116).

19. The cooking robot system (100) of claim 1, wherein the first cooking pot (106) and the second cooking pot (107) both comprising:
a slot (106a,107a) that allows the pair of heating arrangements (112) to detachably engage with the first cooking pot (106) and the second cooking pot (107);
a handle (106b,107b) that allows the user to attach and detach the first cooking pot (106) and the second cooking pot (107) to and from the pair of heating arrangements (112).

20. The cooking robot system (100) of claim 1, wherein the at least one ingredient holding container (116) comprising one or more spaced compartments (116c) on top (116a) for holding the one or more ingredients therein.

21. The cooking robot system (100) of claim 1, wherein the at least one ingredient holding container (116) includes a stretched elastic film (116b) attached at the bottom of the ingredient holding container (116).

22. The cooking robot system (100) of claim 20, wherein each of the one or more spaced compartments (116c) includes a stretched elastic film (116b) attached to the bottom of each of the one or more spaced compartments (116c)

23. The cooking robot system (100) of claim 20, wherein each of the one or more spaced compartments (116c) includes a retractable film (116b) attached to the bottom of each of the one or more spaced compartments (116c) using an adhesive.

24. The cooking robot system (100) of claim 1 further comprising a control circuitry in communication with the motion mechanism (108), the pair of heating elements (112) engaged to the first and second cooking pots (106,107), the stirring mechanism (114), the dispenser assembly (118) for controlling and managing the movement of the first and second cooking pots (106,107) in a 3 Degrees of Freedom (DoF) along the horizontal axis, the vertical axis, and the rotational axis, controlling the heating of the first and second cooking pots (106,107), controlling the mixing of the at least one ingredient contained in the ingredient holding container (116), and dispensing the at least one cooking ingredient contained within the ingredient holding container (116) respectively.

25. The cooking robot system (100) of claim 18, wherein the laser module (118a) is configured for targeting a laser beam at the bottom of the ingredient holding container (116) or the bottom of each of the one or more spaced compartments (116c) to burst or cut the stretched elastic film or the retractable film (116b) attached thereof for dispensing the at least one ingredient held by the ingredient holding container (116).

26. The cooking robot system (100) of claim 18, wherein, the motion mechanism (108) allows the first cooking pot (106) and the second cooking pot (107) to change their orientations based on various cooking needs and type of food being prepared.
